(19) United States
(12) Patent Application Publication
(10) Pub. No.: US 2024/0033630 A1
(43) Pub. Date: Feb. 1, 2024

(54) INTERFACE DISPLAYING METHOD AND APPARATUS, STORAGE MEDIUM, AND ELECTRONIC DEVICE

(71) Applicant: Beijing Zitiao Network Technology Co., Ltd., Beijing (CN)

(72) Inventor: Zhong GUAN, Beijing (CN)

(21) Appl. No.: 18/348,843

(22) Filed: Jul. 7, 2023

(30) Foreign Application Priority Data
Jul. 26, 2022 (CN) 202210888577.5

(51) Int. Cl. A63F 13/5375; A63F 13/52; A63F 13/533

(52) U.S. Cl. CPC A63F 13/5375; A63F 13/52; A63F 13/533; A63F 2300/308

(57) ABSTRACT

An interactive control method, an apparatus, a storage medium, an electronic device is provided. The method includes: displaying an interactive interface corresponding to a target virtual event, in response to a first trigger operation of a user on the target virtual event in a virtual scene, the interactive interface displays a first target value corresponding to the target virtual event and virtual object components corresponding to a plurality of virtual objects; generating, by the virtual object components, a second target value corresponding to each virtual object, in response to a second trigger operation of the user on the interactive interface; determining a number of second target values that meet a preset condition, based on the first target value and the second target value; displaying information about success of the target virtual event, in response to the number of second target values that meet the preset condition reaching a preset threshold.

### CROSS-REFERENCE TO RELATED APPLICATION

The present application claims priority of the Chinese Patent Application No. 202210888577.5, filed on Jul. 26, 2022, the disclosure of which is incorporated herein by reference in its entirety as part of the present application.

### TECHNICAL FIELD

The present disclosure relates to a field of computer technologies, and more particularly, to an interactive control method and an apparatus, a storage medium, and an electronic device.

### BACKGROUND

In some interactive applications, decision of an execution result of a target event is usually involved; for example, in some game applications, the execution result of the target event is decided through a dice, but decision the results of these target event usually directs to a single user or a single character. For situations where multiple user groups or roles are grouped, it is not possible to determine the event results for a whole composed of multiple users or roles.

### SUMMARY

According to a first aspect of the present disclosure, an interactive control method is provided. The method includes:
displaying an interactive interface corresponding to a target virtual event, in response to a first trigger operation of a user on the target virtual event in a virtual scene, wherein the interactive interface displays a first target value corresponding to the target virtual event and virtual object components corresponding to a plurality of virtual objects;
generating, by the virtual object components, a second target value corresponding to each virtual object, in response to a second trigger operation of the user on the interactive interface;
determining a number of second target values that meet a preset condition, based on the first target value and the second target value; and
displaying information about success of the target virtual event, in response to the number of second target values that meet the preset condition reaching a preset threshold.

According to a second aspect of the present disclosure, an interactive control apparatus is provided. The apparatus includes:
a first displaying module, configured to display an interactive interface corresponding to a target virtual event, in response to a first trigger operation of a user on the target virtual event in a virtual scene, wherein the interactive interface displays a first target value corresponding to the target virtual event and virtual object components corresponding to a plurality of virtual objects;
a generating module, configured to generate a second target value corresponding to each virtual object through the virtual object component, in response to a second trigger operation of the user on the interactive interface;
a determining module, configured to determine a number of second target values that meet a preset condition, based on the first target value and the second target value; and
a second displaying module, configured to display information about success of the virtual event, in response to the number of second target values that meet the preset condition reaching a preset threshold.

According to a third aspect of the present disclosure, an electronic device is provided. The electronic device includes: a processor and a memory, wherein, the memory stores machine-readable instructions that may be executed by the processor; when the electronic device is running, the processor executes the machine-readable instructions to implement the steps of the above-mentioned method.

According to a fourth aspect of the present disclosure, a computer-readable storage medium is provided. The computer-readable storage medium has a computer program stored thereon, wherein the computer program, upon executed by a processor, implements the steps of the above-mentioned method.

In the embodiments of the present disclosure, two-level decision is performed on a virtual team composed of a plurality of virtual objects by setting a first target value and a preset threshold, to respectively decide whether a second target value corresponding to each virtual object in the virtual team meets a preset condition and whether the number of second target values that meet the preset condition exceeds the preset threshold, so as to determine whether a target virtual event is successful, and present a corresponding visual effect in the interactive interface, that is, present a corresponding target situation with a corresponding visual effect. Execution results of a target event for a whole composed of multiple objects can be determined, thereby the user experience can be improved.

It should be understood that the general description above and the detailed description in the following are only illustrative and explanatory, and not limiting the disclosure.

Based on the detailed explanation of exemplary embodiments with reference to the accompanying drawings below, other features and aspects of the present disclosure will become clear.

### BRIEF DESCRIPTION OF THE DRAWINGS

In order to provide a clearer explanation of the technical solution of the disclosed embodiments, a brief introduction will be given to the accompanying drawings required in the embodiments. It is obvious that the accompanying drawings in the following only relate to some embodiments of the present disclosure. For ordinary technical personnel in the art, other accompanying drawings can be obtained based on these drawings without any creative effort.

FIG. 1 is a schematic diagram of a network architecture according to embodiments of the present disclosure;

FIG. 2 is a flow chart of an interactive control method according to embodiments of the present disclosure;

FIG. 3 is a flow chart of generating a second target value according to embodiments of the present disclosure;

FIG. 4 is a flow chart of a method for determining the number of second target values that meet a preset condition according to embodiments of the present disclosure;

FIG. 5 is a flow chart of an interactive control method according to embodiments of the present disclosure;

FIG. 6 is a modular schematic diagram of an interactive control apparatus according to embodiments of the present disclosure;

FIG. 7 is a schematic block diagram of an electronic device according to embodiments of the present disclosure;

FIG. 8 is a structural block diagram of an electronic device according to embodiments of the present disclosure; and

FIG. 9A to FIG. 9D are schematic diagrams of an interface for interactive control in a game according to embodiments of the present disclosure.

### DETAILED DESCRIPTION

The following will provide a clear and complete description of the technical solution in the embodiments of this specification in conjunction with the accompanying drawings. Obviously, the described embodiments are only a part of the embodiments of this specification, not all of them. This disclosure can be implemented in various forms and should not be construed as limited to the embodiments described here. On the contrary, these embodiments are provided for a more thorough and complete understanding of this disclosure. It should be understood that the accompanying drawings and embodiments disclosed in this disclosure are only for illustrative purposes and are not intended to limit the scope of protection of this disclosure.

It should be understood that the various steps recorded in the disclosed method implementation can be executed in different orders and/or in parallel. In addition, the method implementation may include additional steps and/or omitting the steps shown for execution. The scope of this disclosure is not limited in this regard.

The term “including” and its variations used herein are open-ended, meaning “including but not limited to”. The term “based on” refers to “at least partially based on”. The term “one embodiment” means “at least one embodiment”. The term “another embodiment” means “at least one other embodiment”. The term “some embodiments” means “at least some embodiments”. The relevant definitions of other terms will be given in the following description. It should be noted that the concepts such as “first” and “second” mentioned in this disclosure are only used to distinguish different devices, modules or units, and are not intended to limit the order or interdependence of the functions performed by these devices, modules or units.

It should be noted that the modifications of “one” and “multiple” mentioned in this disclosure are indicative rather than restrictive, and those skilled in the art should understand that unless otherwise explicitly stated in the context, they should be understood as “one or more”.

Names of messages or information interacted between a plurality of apparatuses according to the implementations of the present disclosure are only used for illustrative purposes, and are not used to limit the scope of these messages or information.

Hereinafter, various exemplary embodiments, features, and aspects of the present disclosure will be illustrated in detail with reference to the accompanying drawings. Same reference signs in the accompanying drawings indicate elements with same or similar functions. Although various aspects of the embodiments are shown in the accompanying drawings, unless specifically pointed out, the drawings do not need to be drawn to scale.

The specialized word “exemplary” here means “being used as an example or an embodiment, or being illustrative”. Any embodiment illustrated here as “exemplary” needs not be interpreted as superior to or better than other embodiments.

The term “and/or” herein is only an association relationship describing associated objects, representing that there may be three types of relationships, for example, A and/or B, may represent three cases of: A alone, coexistence of A and B, and B alone. In addition, the term “at least one” herein represents any one of a plurality of items or any combination of at least two of a plurality of items, for example, including at least one of A, B and C, may represent any one or more elements selected from a set composed of A, B and C.

In addition, in order to better illustrate the present disclosure, numerous specific details are provided in specific implementations below. Those skilled in the art should understand that without certain specific details, the present disclosure may also be implemented. In some embodiments, methods, means, elements, and circuits familiar to those skilled in the art are not described in detail, so as to highlight the main purpose of the present disclosure.

Firstly, relevant terms involved in the present disclosure are defined as follows:

User terminal, which is an input/output device used by a user to interact with a computer system, mainly including various types of computer terminal devices. The user terminal may be, for example, a mobile phone, a tablet personal computer, a laptop, a recreational machine, a palmtop computer, a wearable device (e.g., Virtual Reality (VR) glasses, a VR helmet, a smart watch, etc.), but is not limited thereto.

The user terminal usually has an operating system; and the operating system, for example, may include Android, IOS, Windows Phone, Windows, etc., and may support running various applications, for example, virtual social applications, 3D maps, games, etc. Wherein, the terminal may display a graphical user interface for any of the above-described applications; the graphical user interface generally refers to an interface corresponding to the application displayed on the terminal, the user may operate the application or acquire information exhibited by the application through the graphical user interface; for example, the user may watch and operate a game through the graphical display interface in a game client, or the user may watch live broadcasts or participate in live e-commerce through a graphical user interface in a live streaming client.

Server, which generally refers to a computer system that is accessed to a network and provides certain services to the user terminal, and usually has higher stability, security, storage capacity, and computing performance than an ordinary user terminal.

User interface, which is a channel for information exchange between humans and computers; the user inputs information to the computer through the user interface for operation, and the computer provides information to the user through the user interface for the user to know the information, as well as analyze and make decisions according to the information. The user interface is, for example, a conversation window in instant messaging software, a website page, a game page, etc.

Verification or decision: a term mainly used in some games; in some games, a character in the game executes a certain action and generates an action result, and decision of the action result is referred to as verification. In some games adopting a dice algorithm, for example, a battle between two characters, an outcome of the battle is determined by a sum of a random number rolled by the dice and the character's own attribute value; for example, in a battle between character A and character B, if character A rolls the dice to gain 5 points and a current battle value of character A is 3, character B rolls the dice to gain 6 points and a current battle value of character B is 4, then character A has a total point of 8, and character B has a total point of 10, so the battle is won by character B.

Team up: building a team by two or more members to jointly carry out tasks.

Virtual character, which generally refers to an image created in literary and artistic works that does not exist in reality, and is also referred to as a “virtual object” herein.

Virtual scene, which generally refers to a humanistic environment fabricated fictitiously, usually adopted in literary works such as novels, dramas, movies, teleplays, and various game software.

Non-Player Character (NPC), which generally refers to a character in a game or an application that is not controlled by a user; the NPC may be controlled by a computer, for example, through set rules and programs, and is a character having its own behavior patterns.

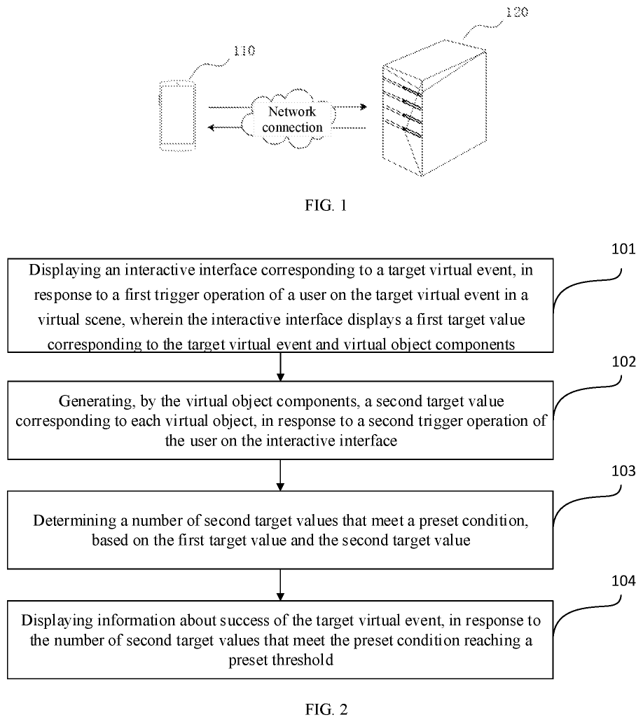

FIG. 1 shows a network architecture; and the network architecture includes a terminal 110 and a server 120.

The interactive control method provided by the embodiments of the present disclosure may be implemented in the network architecture as shown in FIG. 1, which may be implemented by the terminal 110 alone or implemented jointly by the terminal 110 and the server 120.

The terminal 110 may be, for example, a mobile phone, a tablet personal computer, a laptop, a recreational machine, a palmtop computer, a wearable device (e.g., Virtual Reality (VR) glasses, a VR helmet, a smart watch, etc.), but is not limited thereto. The terminal 110 may run a client with backend service provided by the server 120.

The server 120 may be an independent physical server, or may also be a server cluster composed of a plurality of physical servers, or a distributed system; and the terminal 110 and the server 120 may be connected through a wired or wireless network. The server 120 may provide service to a client running on the terminal 110, thereby supporting interaction between the terminal 110 and the user through the client; the client may acquire operation information of the user through interaction with the user, interact with the server 120 based on the operation information to acquire information that needs to be displayed, and render the information on the above-described target interface.

In some embodiments, the terminal 110 may independently generate and exhibit the target interface in response to an instruction, and the user using the terminal 110 may execute an operation on the target interface, for example, when an interactive application is directly deployed on the terminal. In other embodiments, when the interactive application is deployed on the terminal 110 as a client and the server provides service to the terminal through the client, the terminal 110 may request generation of a target interface from the server 120 in response to an instruction; the server 120 sends the target interface or information for generating the target interface to the terminal 110; and the terminal 110 exhibits the target interface for the user to browse or operate.

In some interactive applications, execution with respect to a target virtual event is usually involved, for example, in game applications, execution of a target task, challenge to a target opponent, etc. is involved; usually, it is decided whether the target virtual event may be successfully completed, whether the target task may be successfully executed, or whether the target opponent may be successfully challenged, with respect to a single user and/or a single virtual object.

In existing games, there are a plurality of target virtual events that may have an execution result decided through verification. For example, when a user-controlled virtual object interacts with an NPC, a decision operation will be performed on a preset target value of the target virtual event according to needs, and it will be confirmed whether the execution result is successful or failed according to the decision result.

However, how to implement execution for a target virtual event in an interactive application with respect to a virtual team composed of a plurality of virtual objects is rarely considered in existing technologies.

Embodiments of the present disclosure provides an interactive control method, applicable for deciding an execution result for a target virtual event in an interactive application with respect to a virtual team. FIG. 2 illustrates a flow chart of the interactive control method provided according to embodiments of the present disclosure. Hereinafter, the interactive control method provided by the embodiments of the present disclosure will be described with reference to FIG. 2; the method is applicable to deciding an execution result of a target virtual event with respect to a plurality of virtual objects, and the method includes:
S101: displaying an interactive interface corresponding to a target virtual event, in response to a first trigger operation of a user on the target virtual event in a virtual scene, in which, the interactive interface displays a first target value corresponding to the target virtual event and virtual object components corresponding to a plurality of virtual objects.
S102: generating, by the virtual object components, a second target value corresponding to each virtual object, in response to a second trigger operation of the user on the interactive interface;
S103: determining a number of second target values that meet a preset condition, based on the first target value and the second target value; and
S104: displaying information about success of the target virtual event, in response to the number of second target values that meet the preset condition reaching a preset threshold.

Wherein, the “plurality of” includes various situations such as two or more, three or more, four or more, and so on.

In some embodiments, in response to the number of second target values that meet the preset condition not reaching the preset threshold, a message indicating failure of the virtual event is displayed.

In the above-described method, by respectively setting the first target value and the preset threshold, decision of the execution result for the target virtual event with respect to a plurality of virtual objects may be implemented. As compared with the existing technology in which decision may only be performed with respect to a single user or a single virtual object, the method according to the present disclosure is more applicable to decision of the execution result for the target virtual event with respect to a plurality of users and/or a plurality of virtual objects. Thus, applicable scenarios of the interactive application can be enriched, and better interactive experience can be provided.

In some embodiments, the virtual scene may be virtual space time related to a plot in a game, providing an environment for a virtual object or character to implement actions or behaviors required by game settings, for example, a boulder transportation scene or a character combat scene that appears in the game; the plurality of virtual objects may correspond to one user, or may also correspond a plurality of users, for example, all of the plurality of virtual objects may be controlled by one user, or some of the plurality of virtual objects may be controlled by one user, or each of the virtual objects may also be controlled by each user; a virtual object has at least one virtual object component corresponding thereto; and the virtual object component may be an item such as a dice; in some embodiments, one virtual object may have a plurality of identical or different virtual object components; the target virtual event may be an event set in a virtual scene according to needs of the plot, for example, in a game, it may be an action, a behavior, or a task related to the game plot in the virtual scene.

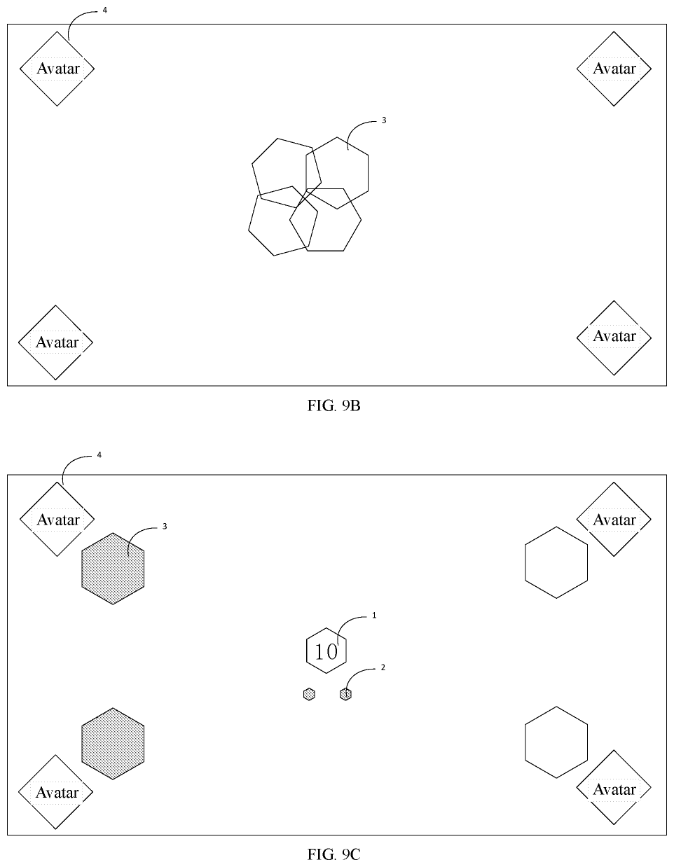

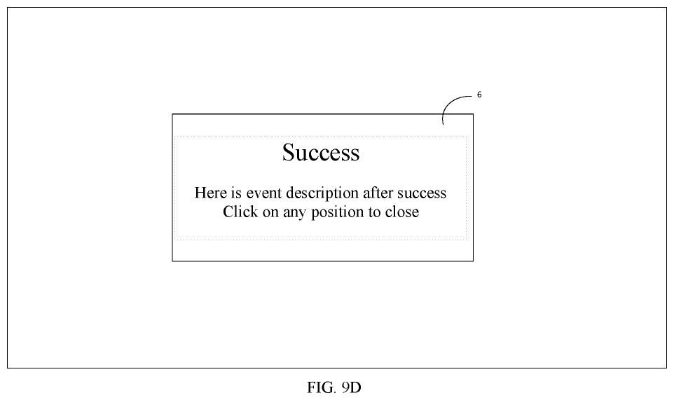

Taking a game as an example, a plurality of virtual characters proceed together in a virtual mountain road scene and encounter a boulder blocking the path; at this time, the game interface prompts that a task of transporting the boulder has to be completed in order to continue proceeding; the user executes the first trigger operation in the current scene, for example, clicking the boulder, clicking a button (indicating acceptance of the task or entering a next step), or performing no operation for a specified duration until the system defaults that the user agrees to execute the task of transporting the boulder; at this time, an interactive interface related to boulder transportation is displayed in the game, the interactive interface may be as shown in FIG. 9A; and the first target value “10” and a visual element 3 representing the virtual object component are displayed in the interactive interface.

In some embodiments, the interactive interface further displays event indication information; and the event indication information is used to indicate the preset threshold and/or the number of second target values that meet the preset condition.

For example, in FIG. 9A, a visual element 2 (i.e. the event indication information) represented by two dice shapes represents that the preset threshold is 2; furthermore, the visual element 2 indicates the number of second target values that meet the preset condition by presenting one or some visual effects, for example, a lighting-up effect of one visual element 2 indicates that the number of second target values that meet the preset condition is 1.

The first target value and the event indication information may usually represent a difficulty level of an event together, and may be determined by a system default configuration or be determined based on at least one of the following on the basis of the system default configuration: target virtual event, virtual team attribute, and virtual scene attribute. That is, first target values and event indication information corresponding to different events may be different; when different virtual teams complete a same target event, first target values and event indication information of the same event may be different, for example, attributes and quantity of virtual objects in the team, as well as association relationships between different virtual objects (race, constraints between different virtual objects, etc.) will affect the first target values and the event indication information of the target virtual event; in different game scenarios (e.g., snowy day, rainy day, or sunny day in virtual game scenarios); a same event may also correspond to different first target values and event indication information. In some embodiments, the virtual object is also displayed in the interactive interface, as shown in FIG. 9A, the virtual object is presented in the interactive interface as a visual element 4, with each virtual object set adjacent to a virtual object component corresponding thereto.

In some embodiments, prompt information and description information are also displayed in the interactive interface; the prompt information includes information used for prompting information related to the second trigger operation, and the description information is used for describing a scene or a plot related to the target virtual event.

For example, in FIG. 9A, the prompt information is displayed through a visual element 52 for prompting the user to execute the second trigger operation, and the description information is displayed through a visual element 51 for describing information related to a scene or a plot of current boulder transportation. In FIG. 9A, the visual element 51 and the visual element 52 may be textual elements, but the visual element 51 and the visual element 52 may also be other types, for example, images, animations, or may also be presented using voice at a same time.

By displaying the prompt information and/or the description information, the interaction process may be explained for the user; throughout the entire interaction process, the target virtual event may only be one link, one plot, or one task; corresponding prompt, description, and explanation in the interactive interface that are displayed in response to the first trigger operation may help the user obtain a better immersive experience effect during the interaction process, and also help the user understand subsequent operations.

The user may execute the second trigger operation based on the prompt information, or the user may also execute the second trigger operation based on his/her understanding of general conventional settings of the game without the prompt information; the second trigger operation includes but is not limited to clicking any position, clicking a button, or performing no operations for a specified duration to execute system default entry, etc.; in some specific embodiments, the second trigger operation may be, for example, clicking on an arbitrary visual element 3 representing a virtual object component as shown in FIG. 9A.

In some embodiments, the prompt information and the description information are also displayed in the interactive interface in step S101; and in response to the second trigger operation, the prompt information and the description information are no longer displayed in the interactive interface.

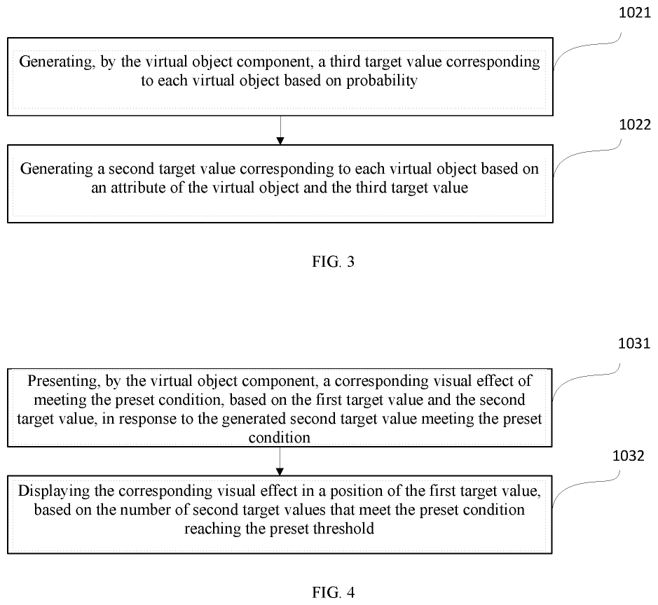

In some embodiments, step S102 specifically includes the following steps as shown in FIG. 3:
S1021: generating, by the virtual object components, a third target value corresponding to each virtual object based on probability.
S1022: generating a second target value corresponding to each virtual object based on an attribute of the virtual object and the third target value.

In some embodiments, the third target value corresponding to each virtual object generated based on probability may be generated in a variety of ways: the third target value may be generated based on a probability function; further, out of consideration of a fairness principle, the third target value may be generated based on a random function, for example, may be directly generated based on a random sequence, or may also be a value generated based on a random sequence that conforms to a preset rule, for example, may be a positive integer generated based on a random sequence and meeting a preset value interval.

The positive integer generated based on a random sequence and meeting a preset value interval, for example, may be generated by means of a turntable or a dice; and these modes facilitate the interactive application to exhibit the generation process, thereby increasing interactivity and playfulness with the user, and further improving user experience.

Taking generation of the third target value based on a dice as an example, step S1021 further includes:
Randomly generating, by a dice component, a third target value corresponding to each virtual object, the third target value being a positive integer from 1 to S, where, the number of faces of the dice is S.

In some embodiments, the second target value may be equal to the third target value.

In other embodiments, as described in step S1022, the second target value is generated based on the third target value and the attribute of the virtual object, wherein, the attribute of the virtual object includes but is not limited to dimensions such as occupation, skill, race, level, etc.

In some embodiments, step S1022 may further include at least one of below:

Performing operations on a value representing the attribute of the virtual object and the third target value, to generate the second target value, where, the operations include but are not limited to addition, subtraction, multiplication, and division; the value representing the attribute of the virtual object may be offensive power, defense power, strength, speed, health point, etc., or may also be corresponding values under the target virtual event according to attributes thereof, for example, different vocations of the virtual objects correspond to different values during boulder transportation. Various implementation modes may be set according to game plots or rules, and no details will be repeated here.

One implementation of step S102 is described above; the above-described mode may be implemented implicitly or explicitly during the interaction process; and the explicit mode will be described below.

The step S102 further includes: displaying a visual effect corresponding to an action of generating the second target value on the interactive interface.

Wherein, the visual effect corresponding to the action of generating the second target value includes one of below:

On the interactive interface, the virtual object components simultaneously start and stop the action; or,

On the interactive interface, the virtual object components successively start and stop the action in a preset order.

The visual effect includes at least one of: brightness change, shape change, size change, position change, action change, and new special effects.

As shown in FIG. 9A, in response to the second trigger operation, the visual element 3 representing the virtual object component displays the visual effect corresponding to the action of generating the second target value on the interactive interface; in some embodiments, four visual elements 3 simultaneously start and stop the action, and the action may be performed independently or jointly, as shown in FIG. 9B; in other embodiments, four visual elements 3 successively start and stop the action of generating the second target value in a preset order, for example, from a visual element 3 in an upper left corner, the four visual elements 3 successively start and stop in a clockwise order or a counterclockwise order; visual effects of visual elements 3 may include: upsizing, color brightening to attract visual attention of the user, and starting a three-dimensional flipping action, for example, simulating dice rolling.

In some embodiments, as the action of generating the second target value stops, the visual effect corresponding to the action also stops, for example, the state of the visual element before the action occurs is restored, or for example, the visual element becomes stationary in a position where the action stops; or as brightness dims at a same time, the user is prompted that the action of generating the second target value has stopped.

Subsequently, proceed to step S103: determining the number of second target values that meet the preset condition, based on the first target value and the second target value.

In some embodiments, the preset condition is: being not less than the first target value; in other embodiments, the preset condition may also be more stringent, for example, is being equal to the first target value; or may also be set correspondingly based on difficulty of the target virtual event.

The first target value is also related to difficulty of completing the target virtual event; in some embodiments, the first target value is determined based on at least one of: target virtual event, attributes of the virtual team, and attributes of the virtual scene; the virtual team is composed of the plurality of virtual objects; and the attributes of the virtual team include attributes of virtual objects and a quantity of the virtual objects, as well as association relationships between the virtual objects.

In some embodiments, a benchmark target value is determined for each target virtual event, and the first target value is dynamically adjusted on the basis of the benchmark target value according to the attributes of the virtual team and/or virtual scene attributes; for example, the target virtual event of boulder transportation may occur in a virtual scene of the virtual team proceeding, or may also occur in a virtual scene of the virtual team mining treasures; in the two different virtual scenes, the first target values may be different; with respect to configurations of different virtual teams, due to different composition, quantity, and relationships of virtual objects of the virtual teams, different virtual teams may correspond to different capability characteristics; with respect to the same target virtual event of boulder transportation, completion difficulties of respective virtual teams may also be different, which may be implemented by adjusting the benchmark target value differently for virtual teams having different attributes.

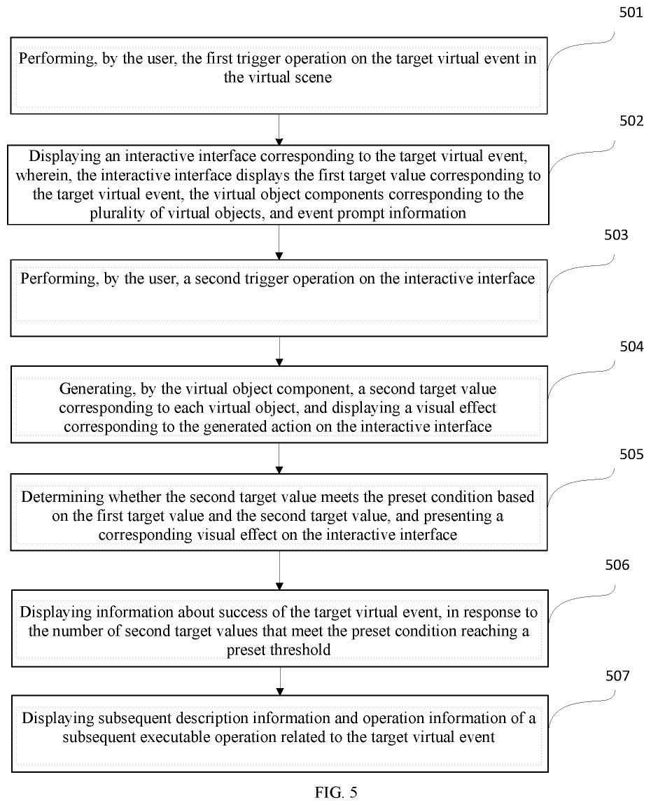

Step S103 may be implemented in an implicit or explicit mode during the interaction process; the step S103 presented in an explicit mode will be described below; and as shown in FIG. 4, the step S103 further includes:
S1031: presenting, by the virtual object components, a corresponding visual effect of meeting the preset condition, based on the first target value and the second target value, in response to the generated second target value meeting the preset condition.
S1032: displaying the corresponding visual effect in a position of the first target value, based on the number of second target values that meet the preset condition reaching the preset threshold.

In some embodiments, when there is event indication information displayed in the interactive interface, the event indication information of the interactive interface presents a corresponding visual effect in response to the second target value meeting the preset condition and/or presents a corresponding visual effect in response to the number of second target values that meeting the preset condition reaching the preset threshold.

In some embodiments, the event indication information shown is presented through two visual elements 2 as shown in FIG. 9A, indicating that the number of second target values that meet the preset condition needs to reach more than 2, i.e. the preset threshold is 2; besides, in response to each generated second target value meeting the preset condition, as shown in FIG. 9A, when the generated second target value is greater than or equal to 10, the visual element 2 presents a visual effect of lighting up, and when a condition of generating at least two second target values greater than 10 is met, both visual elements are lit up, indicating that the number of second target values that meet the preset condition reaches the threshold; in some embodiments, special dynamics may also be presented in a position of the event indication information and/or in a position of the virtual object component, to express that the standard set for the target virtual event is met by enhancing the visual effect of the user.

Taking a game of a virtual team as an example, the game sets up a section of the virtual team mining a treasure box; the virtual team may be composed of, for example, 4 virtual objects, as shown in FIG. 9A; a second target value is generated for each virtual object of the virtual team, and the second target value is modified by a random number generated by each virtual object through its own turntable or through its own mana or intelligence attribute; on the interactive interface, the first target value is displayed as 10, and two visual elements 2 are displayed to indicate that at least two second target values need to exceed 10; the user clicks on any position to start the process of generating the second target value; when the second target value is greater than or equal to the first target value, a visual element 3 of a corresponding turntable presents a visual effect such as flashing, reinforced borders, etc.; and optionally, the generated second target value may be displayed.

The number of second target values that meet the preset condition is determined through step S103; at a same time or after the step, it is decided whether the number reaches the preset threshold; and when the preset threshold is reached, a corresponding visual effect may be presented in a position of the first target value.

In the interactive application, displaying clear instructions to make the user know information about success of the corresponding target virtual event will improve interaction experience of the user; so, in step S104, the information about success of the target virtual event is further displayed.

The information about success of the target virtual event may be displayed in the current interactive interface, or may also be displayed in a new interactive interface after closing the current interactive interface.

In other embodiments, when the number of second target values that meet the preset condition does not reach the preset threshold, information about failure of the target virtual event is displayed; and the information about failure of the target virtual event may be displayed in the current interactive interface, or may also be displayed in a new interactive interface after closing the current interactive interface.

For example, in game-based interactive applications, a virtual team composed of two or more virtual objects may complete a target virtual event; the virtual objects may be controlled by a same user, or may also be controlled by different users, as shown in FIG. 9A; the visual element 4 may be a virtual object in the game; the visual element 3 may be a virtual object component corresponding to the virtual object, for example, a dice, a turntable, and a card; each virtual object component generates a second target value for each virtual object, for determining whether it is greater than or equal to the first target value; the number of second target values greater than or equal to the first target value among all the virtual objects in the virtual team needs to be greater than 2.

In some embodiments, when the target virtual event is displayed as successful, the method further includes displaying at least one type of information below:

Subsequent description information related to describing subsequent scene or plot of the target virtual event;

Operation information related to closing the interactive interface; and

Operation information of a subsequent executable operation related to the target virtual event.

The subsequent description information may be information on how to continue interaction; for example, in the above-described embodiment, it may be that the boulder blocks the path of the group members, and the group members need to choose another path to continue.

The operation information of the executable operation may be how to proceed so as to enter a next section.

FIG. 5 shows an interactive control method according to embodiments of the present disclosure, the method includes:
S501: performing, by the user, the first trigger operation on the target virtual event in the virtual scene.
S502: displaying an interactive interface corresponding to the target virtual event, wherein, the interactive interface displays the first target value corresponding to the target virtual event, the virtual object components corresponding to the plurality of virtual objects, and event prompt information.
S503: performing, by the user, a second trigger operation on the interactive interface.
S504: generating, by the virtual object components, a second target value corresponding to each virtual object, and a visual effect corresponding to the generated action is displayed on the interactive interface.
S505: determining whether the second target value meets the preset condition based on the first target value and the second target value, and presenting a corresponding visual effect on the interactive interface.
S506: displaying information about success of the target virtual event, in response to the number of second target values that meet the preset condition reaching a preset threshold.
S507: displaying subsequent description information and operation information of a subsequent executable operation related to the target virtual event.

The embodiment of the present disclosure provides an interface displaying method for implementing team decision in a game, as shown in FIG. 9A to FIG. 9D, in the game, a team composed of four virtual character members is faced with a target event of boulder transportation in a virtual scene; and the game has a mechanism set for deciding whether boulder transportation is successful. As shown in FIG. 9A, the interface presents an illustration layer about boulder transportation; the layer displays description information about the interface and prompt information of clicking on any dice for a trigger operation; meanwhile, the interface presents avatars 4 of four virtual characters, a dice 3 adjacent to each avatar, a center dice 1 set with a target value of 10, and two small dices 2 in the vicinity of the center dice; the target value 10 represents the first target value; a dice for representing a single virtual character member needs to have a value greater than or equal to 10; the two small dices represent a preset threshold; a condition for event success is that the number of dices of virtual characters that have a value greater than or equal to the first target value must reach 2; in the decision, the dices of the respective virtual character members may be the same or different; for example, if the dices are all 20-sided dices, each dice may gain a random integer between 1 and 20; by clicking on a preset position or any dice on the interface, a dice rolling process is triggered; as shown in FIG. 9B, a picture in a dice performance action video stream is presented; the dice rolling process may be started and stopped simultaneously by the four dices in FIG. 9B, or may also be started from one of the four dices and stopped successively in a certain order, which may be clockwise or counterclockwise; as the dices stop, each dice gains a dice value, and the dice value may be directly equal to a random number per se generated during the dice rolling process, or may also be modified on the basis of the random number per se, for example, increasing or decreasing the random number according to attribute values of the virtual character; when a dice value gained by a dice is greater than or equal to the first target value of 10, the dice may present a visual effect to make the user know in a more obvious way that the dice meets the preset condition, that is, being greater than or equal to the first target value; at a same time or after the dice presents a visual effect of meeting the first target value, one of the two small dices presents a visual effect, for example, lighting up, to express that there is one dice already meeting the preset condition; when a dice value gained by a second dice is greater than or equal to the target value of 10, the dice may present a visual effect to make the user know in a more obvious way that the dice also meets the preset condition; the visual effect presented by the dice may be the same or different from the visual effect of the dice that previously meets the preset condition; at a same time or after the visual effect of meeting the preset condition as presented by the dice, the other of the two small dices also presents a visual effect, for example, lighting up, to express that there are two dices already meeting the preset condition, as shown in FIG. 9C, at this time, it also means that the preset threshold has been reached, and the center dice presents a visual effect to express that the preset threshold has been reached; under the decision rule, having reached the preset threshold means that the target virtual event is decided to be successful, and accordingly, it indicates that the boulder may be successfully transported.

In the above-described embodiments, in some cases, if there is only one virtual character member whose dice meets the first target, it means that the second target is not met; at this time, a result for the target virtual event is decided as failed, and accordingly, it indicates that boulder transportation is failed.

In the above-described embodiment, in order that the user continues to complete the subsequent interaction process, as shown in FIG. 9D, a layer 6 is presented after the decision result is completed; the layer may be a transparent layer or an opaque layer overlaying on top of the current interface; and the layer displays information about whether the decision result is a success or a failure, as well as subsequent description information and operable information.

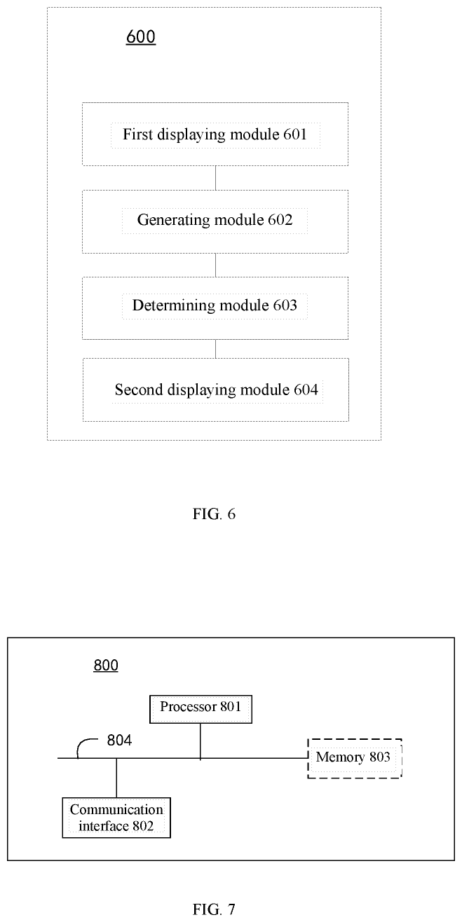

In a case of dividing respective functional modules by adopting respective corresponding functions, as shown in FIG. 6, it is a structural schematic diagram of an interactive control apparatus provided by an embodiment of the present disclosure.

As shown in FIG. 6, there is provided an interactive control apparatus, including:
A first displaying module 601, configured to display an interactive interface corresponding to a target virtual event, in response to a first trigger operation of a user on the target virtual event in a virtual scene; the interactive interface displaying a first target value corresponding to the target virtual event and virtual object components corresponding to a plurality of virtual objects;
A generating module 602, configured to generate a second target value corresponding to each virtual object by the virtual object components, in response to a second trigger operation of the user on the interactive interface;
A determining module 603, configured to determine the number of second target values that meet a preset condition, based on the first target value and the second target value; and
A second displaying module 604, configured to display information about success of the virtual event, in response to the number of second target values that meet the preset condition reaching a preset threshold. For the apparatus according to the above-described embodiment, the specific modes in which the respective modules execute operations have been described in detail in the embodiments related to the method, and no details will be repeated here.

FIG. 7 shows a schematic block diagram of an electronic device according to an exemplary embodiment of the present disclosure. As shown in FIG. 7, the electronic device 800 includes one or more (including two) processors 801 and a communication interface 802. The communication interface 802 may support the server to execute the data receiving and sending steps in the above-described method; and the processor 801 may support the server to execute the data processing step in the above-described method.

Optionally, as shown in FIG. 7, the chip 800 further includes a memory 803; the memory 803 may include a read-only memory and a random-access memory, and provide operating instructions and data to the processor. A portion of the memory may further include a non-volatile random-access memory (NVRAM).

In some implementations, as shown in FIG. 7, the processor 801 executes corresponding operations by calling operation instructions stored in the memory (the operation instructions may be stored in the operating system). The processor 801 controls processing operations of any one of the terminal devices; and the processor may also be referred to as a Central Processing Unit (CPU). The memory 803 may include a read-only memory and a random-access memory, and provide instructions and data to the processor 801. A portion of the memory 803 may further include NVRAM. For example, the memory in the application, the communication interface, and the memory are coupled together through a bus system, wherein, the bus system further includes a power bus, a control bus and a state signal bus in addition to a data bus. However, for sake of clarity, various buses are labeled as a bus system 804 in FIG. 7.

The method disclosed in the above-described embodiments of the present disclosure may be applied to the processor, or implemented by the processor. The processor may be an integrated circuit chip, and has signal processing capabilities. During the implementation process, the respective steps of the above-described method may be completed through the integrated logic circuit of the hardware in the processor or instructions in the form of software. The above-described processor may be a general-purpose processor, a Digital Signal Processor (DSP), an Application Specific Integrated Circuit (ASIC), a Field Programmable Gate Array (FPGA) or other programmable logic device, a discrete gate or a transistor logic device, and a discrete hardware component. Various methods, steps, and logical block diagrams as described in the embodiments of the present disclosure may be implemented or executed. The general-purpose processor may be a microprocessor, or the processor any also be any conventional processor, etc. The steps of the method disclosed in combination with the embodiments of the present disclosure may be directly embodied to be completed through execution by the hardware decoding processor or to be completed through execution by a combination of hardware and software modules in the decoding processor. The software module may be located in mature storage media in the art, such as a random-access memory, a flash memory, a read-only memory, a programmable read-only memory, or an electrically erasable programmable memory, a register, etc. The storage medium is located in the memory; and the processor reads the information in the memory and completes the steps of the above-described method in combination with the hardware thereof.

An exemplary embodiment of the present disclosure further provides an electronic device, including: a processor and a memory, in which, the memory stores machine-readable instructions that may be executed by the processor. When the electronic device is running, the processor runs the machine-readable instructions to execute the method according to the embodiments of the present disclosure.

An exemplary embodiment of the present disclosure further provides a computer-readable storage medium, in which, the computer-readable storage medium has a computer program stored thereon; and when run by the processor, the computer program executes the method according to the embodiments of the present disclosure.

An exemplary embodiment of the present disclosure further provides a computer program product, including a computer program, in which, when executed by a processor of a computer, the computer program executes the method according to the embodiments of the present disclosure.

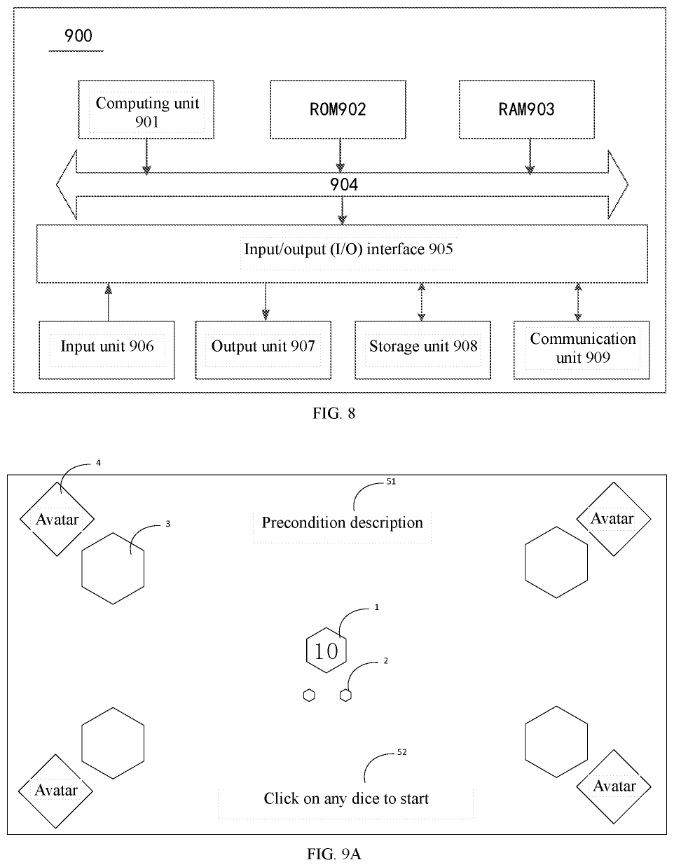

As shown in FIG. 8, the electronic device 900 includes a computing unit 901, which may execute various appropriate actions and processing according to a computer program stored in a Read-Only Memory (ROM) 902 or a computer program loaded from a storage unit 908 into a Random Access Memory (RAM) 903. The RAM 903 further stores various programs and data required for operation of the electronic device 900. The computing unit 901, the ROM 902, and the RAM 903 are connected with each other through a bus 904. An input/output (I/O) interface 905 is also coupled to the bus 904.

A plurality of components in the electronic device 900 are coupled to the I/O interface 905, including: an input unit 906, an output unit 907, a storage unit 908, and a communication unit 909. The input unit 906 may be any type of device capable of inputting information to the electronic device 900; the input unit 906 may be configured to receive input digital or character information, and generate key signal inputs related to user settings and function control of the electronic device. The output unit 907 may be any type of device capable of presenting information, and may include, but is not limited to, a display, a speaker, a video/audio output terminal, a vibrator, and/or a printer, etc. The storage unit 904 may include, but is not limited to, a magnetic disk and an optical disk. The communication unit 909 allows the electronic device 900 to exchange information/data with other devices through computer networks such as the Internet and/or various telecommunications networks, and may include but not be limited to, a modem, a network card, an infrared communication device, a wireless communication transceiver and/or a chipset, for example, a Bluetooth™ device, a WiFi device, a WiMax device, a cellular communication device and/or the like.

The computing unit 901 may be various general-purpose and/or special-purpose processing components having processing and computing capabilities. Some examples of the computing unit 901 include but are not limited to, a Central Processing Unit (CPU), a Graphics Processing Unit (GPU), various special-purpose Artificial Intelligence (AI) computing chips, various computing units running machine learning model algorithms, a Digital Signal Processor (DSP), and any appropriate processors, controllers, microcontrollers, etc. The computing unit 901 executes respective methods and processing as described above. For example, in some embodiments, the above-described method may be implemented as a computer software program, which is tangibly included in a machine-readable medium, for example, a storage unit 908. In some embodiments, some or all of the computer program may be loaded and/or installed on the electronic device 900 via the ROM 902 and/or the communication unit 909. In some embodiments, the computing unit 901 may be configured to execute the above-described method by any other appropriate means (e.g., by virtue of firmware).

The program codes for implementing the method according to the present disclosure may be written in any combination of one or more programming languages. These program codes may be provided to a processor or a controller of a general-purpose computer, a special-purpose computer, or other programmable data processing apparatus, so that when executed by the processor or the controller, the program codes cause the functions/operations specified in the flow chart and/or the block diagram to be implemented. The program codes may be completely executed on the machine, partially executed on the machine, partially executed as independent software packages on the machine, and partially executed on remote machines or completely executed on remote machines or servers.

In the context of the present disclosure, the machine-readable medium may be a tangible medium, which may contain or store programs for use by or in combination with an instruction executing system, an apparatus or a device. The machine-readable medium may be a machine-readable signal medium or a machine-readable storage medium. Machine-readable media may include, but are not limited to, electronic, magnetic, optical, electromagnetic, infrared, or semiconductor systems, apparatuses, or devices, or any suitable combination of the above contents. A more specific example of the machine-readable storage medium would include an electrical connection based on one or more lines, a portable computer disk, a hard disk, a Random Access Memory (RAM), a Read-Only Memory (ROM), an Erasable Programmable Read-Only Memory (EPROM or a flash memory), an optical fiber, a Portable Compact Disk Read-Only Memory (CD-ROM), an optical storage device, a magnetic storage device, or any suitable combination of the above contents.

In order to provide interaction with the user, the system and the technology described here may be implemented on a computer; and the computer has: a display apparatus (e.g., a Cathode Ray Tube (CRT) or a Liquid Crystal Display (LCD) monitor) configured to display information to the user; as well as a keyboard and a pointing apparatus (e.g., a mouse or a trackball) through which the user may provide input to the computer. Other types of apparatuses may also be configured to provide interaction with the user; for example, feedback provided to the user may be any form of sensory feedback (e.g., visual feedback, auditory feedback, or tactile feedback); and the input from the user may be received in any form (including sound input, voice input, or tactile input).

The system and the technology described here may be implemented in a computing system that includes a backend component (e.g., serving as a data server), or in a computing system that includes a middleware component (e.g., an application server), or in a computing system that includes a front-end component (e.g., a user computer having a graphical user interface or a web browser through which the user may interact with implementations of the system and the technology described here), or in a computing system that includes any combination of such back-end component, middleware component, or front-end component. The components of the system may be interconnected through any form or medium of digital data communication (e.g., a communication network). Examples of communication networks include a Local Area Network (LAN), a Wide Area Network (WAN), and the Internet.

The computer system may include both a client and a server. The client and the server are generally far away from each other and usually interact through a communication network. A client-server relationship is generated through computer programs running on corresponding computers and having a client-server relationship with each other.

The above-described embodiments may be implemented in whole or in part by software, hardware, firmware, or any combination thereof. When implemented by software, it may be implemented in a form of a computer program product in whole or in part. The computer program product includes one or more computer programs or instructions. When the computer loads and executes the computer programs or instructions, the flows or functions described in the embodiments of the present disclosure are executed in whole or in part. The computer may be a general-purpose computer, a special-purpose computer, a computer network, a terminal, a user device, or other programmable apparatus. The computer programs or instructions may be stored in a computer-readable storage medium, or transmitted from one computer-readable storage medium to another computer-readable storage medium; for example, the computer programs or instructions may be transmitted from one website, computer, server, or data center to another website site, computer, server or data center in a wired manner or a wireless manner. The computer-readable storage medium may be any available medium that can be accessed by a computer or a data storage device including a server, a data center, etc., integrated by one or more available media. The available medium may be a magnetic medium, for example, a floppy disk, a hard disk, a magnetic tape; or may also be an optical medium, for example, a Digital Video Disc (DVD); or may also be a semiconductor medium, for example, a Solid State Disk (SSD).

Although the present disclosure has been described in conjunction with specific features and implementation examples, it is evident that various modifications and combinations can be made without departing from the spirit and scope of the present disclosure. Correspondingly, this specification and the accompanying drawings are only exemplary illustrations of the present disclosure as defined in the accompanying claims, and are deemed to have covered any and all modifications, variations, combinations, or equivalents within the scope of the present disclosure. Obviously, technical personnel in this field can make various modifications and variations to this disclosure without departing from the spirit and scope of this disclosure. In this way, if these modifications and variations of the present disclosure fall within the scope of the claims and their equivalent technologies, the present disclosure also intends to include these modifications and variations.

What is claimed is:

1. An interactive control method, comprising:
displaying an interactive interface corresponding to a target virtual event, in response to a first trigger operation of a user on the target virtual event in a virtual scene, wherein the interactive interface displays a first target value corresponding to the target virtual event and virtual object components corresponding to a plurality of virtual objects;
generating, by the virtual object components, a second target value corresponding to each virtual object, in response to a second trigger operation of the user on the interactive interface;
determining a number of second target values that meet a preset condition, based on the first target value and the second target value; and
displaying information about success of the target virtual event, in response to the number of second target values that meet the preset condition reaching a preset threshold.

2. The method according to claim 1, wherein, the preset condition is being not less than the first target value;
wherein the interactive interface further displays event indication information, and the event indication information is used to indicate the preset threshold and/or the number of second target values that meet the preset condition.

3. The method according to claim 1, wherein, the first target value is determined based on at least one of:
the target virtual event, attributes of a virtual team, and attributes of the virtual scene,
wherein the virtual team is composed of the plurality of virtual objects; and the attributes of the virtual team comprise attributes of virtual objects, a quantity of the virtual objects, as well as association relationships between the virtual objects.

4. The method according to claim 1, wherein, the generating, by the virtual object components, the second target value corresponding to each virtual object, comprises:
generating, by the virtual object components, a third target value corresponding to each virtual object based on probability; and
generating a second target value corresponding to each virtual object based on an attribute of the virtual object and the third target value.

5. The method according to claim 4, wherein, the generating, by the virtual object components, the second target value corresponding to each virtual object, further comprises:
displaying a visual effect corresponding to an action of generating the second target value on the interactive interface, wherein the visual effect corresponding to the action of generating the second target value comprising one of:
on the interactive interface, the virtual object components simultaneously start and stop the action; or,
on the interactive interface, the virtual object components successively start and stop the action in a preset order.

6. The method according to claim 5, wherein, the visual effect comprises at least one of: brightness change, shape change, size change, position change, action change, and new special effects.

7. The method according to claim 1, wherein, the interactive interface displaying the first target value corresponding to the target virtual event and virtual object components corresponding to the plurality of virtual objects comprises:
further displaying, by the interactive interface, prompt information and description information, wherein the prompt information comprises information used for prompting information related to the second trigger operation, and the description information is used for describing a scene or a plot related to the target virtual event; and
wherein the generating the second target value corresponding to each virtual object, in response to the second trigger operation of the user on the interactive interface further comprises:
not displaying the prompt information and the description information in the interactive interface.

8. The method according to claim 1, wherein, the displaying information about success of the virtual event, in response to the number of second target values that meet the preset condition reaching the preset threshold further comprises:
displaying at least one type of information below:
subsequent description information related to describing subsequent scene or plot of the target virtual event;
operation information related to closing the interactive interface; and
operation information of a subsequent executable operation related to the target virtual event.

9. The method according to claim 1 further comprising:
displaying information about failure of the virtual event, in response to the number of second target values that meet the preset condition not reaching the preset threshold.

10. An interactive control apparatus, comprising:
a first displaying module, configured to display an interactive interface corresponding to a target virtual event, in response to a first trigger operation of a user on the target virtual event in a virtual scene, wherein the interactive interface displays a first target value corresponding to the target virtual event and virtual object components corresponding to a plurality of virtual objects;
a generating module, configured to generate a second target value corresponding to each virtual object through the virtual object component, in response to a second trigger operation of the user on the interactive interface;
a determining module, configured to determine a number of second target values that meet a preset condition, based on the first target value and the second target value; and
a second displaying module, configured to display information about success of the virtual event, in response to the number of second target values that meet the preset condition reaching a preset threshold.

11. An electronic device, comprising: a processor and a memory, wherein, the memory stores machine-readable instructions that may be executed by the processor; when the electronic device is running, the processor executes the machine-readable instructions to implement the steps of the method according to claim 1.

12. A computer-readable storage medium with a computer program stored thereon, wherein the computer program, upon executed by a processor, implements the steps of the method according to claim 1.
